(19) United States
(12) Patent Application Publication
(10) Pub. No.: US 2010/0066614 A1
(43) Pub. Date: Mar. 18, 2010

(54) COMMUNICATING APPARATUS

(75) Inventor: Tetsuya Ishitsuka, Tokorozawa-shi (JP)

Correspondence Address: YOUNG & THOMPSON, 209 Madison Street, Suite 500, Alexandria, VA, 22314, US

(73) Assignee: PIONEER CORPORATION, MEGURO-KU (JP)

(21) Appl. No.: 12/515,607

(22) PCT Filed: Nov. 21, 2006
(86) PCT No.: PCT/JP2006/323205

§ 371 Date: Jul. 15, 2009

(51) Int. Cl. H01Q 1/24

(52) U.S. Cl. 343/702

(57) ABSTRACT

A communication apparatus (100) includes a first antenna (A1) for receiving carriers on which information signals, which are modulated signals, are superimposed; a ground terminal (50) for causing a reference voltage to be close to zero; a second antenna (A2) (i) that is connected to the ground terminal and (ii) that exhibits an electromagnetically opposite polarity to the first antenna; and a signal processing element (10) that processes the received information signals.

### TECHNICAL FIELD

The present invention relates to a communicating apparatus using electromagnetic waves, such as an AM receiver and signal communication equipment.

### BACKGROUND ART

Wireless communication using electromagnetic waves generally includes an AM (Amplitude Modulation) receiving apparatus (a so-called receiving device or receiver) and a receiving antenna. The AM receiving apparatus is normally not earthed to the ground, so the reference potential of the AM receiving apparatus always varies with respect to the ground, which is due to reference terminals, which make the reference potential of voltage switching in a switching power supply, an inner circuit provided with an oscillation circuit, and the AM receiving apparatus, and operations of a plurality of circuit elements, which are connected to the reference terminals.

In the wireless communication, if the frequency of a carrier wave on which a desired information signal (a so-called modulated signal) is superimposed is close to or equal to the frequency of the reference potential variation (the variation in the reference potential), it is hard to receive the desired carrier wave and to perform signal processing. This is because the receiving antenna, connected to the AM receiving apparatus, is connected to the reference potential and operates on the basis of the reference potential, so the receiving antenna receives not only the carrier wave on which the desired modulated signal is superimposed but also a noise corresponding to an electromotive force generated between terminals of the antenna because of the variation in the reference potential. If the noise level is greater than that of the carrier wave on which the desired modulated signal is superimposed, the signal level of the desired modulated signal is relatively reduced, which makes it hardly possible or impossible to receive the carrier wave on which the desired modulated signal is superimposed and to perform the signal processing on the carrier wave. Even if the noise level is relatively small, a SN ratio (Signal to Noise Ratio) is significantly reduced, which likely causes such a communication failure as an audience hardly listens to the desired modulated signal.

For the generation of the noise caused by the variation in the reference potential and a communication jamming caused by the generated noise, the following three main types of countermeasures have been suggested. The first type is to take countermeasures in control methods and part addition, to thereby reduce the noise caused by the reference potential variation, with respect to a circuit operation which causes the variation in the reference potential. The second type is to take structural countermeasures, such as an electromagnetic shield, to thereby avoid the jamming by the noise caused by the reference potential variation. The third type is to earth the reference potential of the AM receiving apparatus to the ground, to thereby stabilize the reference potential.

The first and second countermeasures do not provide a fundamental solution unless the circuit operation, which causes the variation in the reference potential, such as an oscillating operation and voltage switching, is completely stopped or the reference potential of the receiving apparatus is completely isolated from the noise source. Various specific countermeasures were worked in the past; however, there is a limit on effectiveness even if the countermeasures are taken. Moreover, the countermeasures cause an increase in the number of parts and complicated control, which are factors in increased cost.

The third countermeasure sufficiently provides a jamming prevention effect (so-called an effect in which an influence by the noise can be sufficiently prevented) if the reference potential of the receiver can be earthed or grounded to a stable potential. In reality, however, depending on an environment and place in which the communicating apparatus is used, the physically and electrically stable grounding environment is most likely not ensured. Even if the grounding environment can be ensured, it is extremely disadvantageous (or demeritorious) to have a user perform a grounding operation, in terms of the user's convenience, i.e. usability.

A patent document 1 or the like discloses a method of controlling a switching frequency not to influence the frequency of the carrier wave to be received, in accordance with a reception interference occurring if the switching frequency is close to or equal to the reception frequency in the method of controlling the switching power supply, which is one of the causes for the variation in the reference potential, which causes the reception interference and the reduction in the SN ratio.
Patent document 1: Japanese Patent Application Laid Open No. 2005-237044

### DISCLOSURE OF INVENTION

### Subject to be Solved by the Invention

In the aforementioned patent document 1 or the like, however, since the special control method for preventing the generation of the noise, endogenously-caused by the switching power supply, complicates the design of the power supply, it is sometimes hard to change the design from that of the existing communication apparatus in terms of techniques or cost. Even if the generation of the noise from the switching power supply owned by the AM receiver is significantly prevented thanks to the aforementioned patent document 1 or the like, there still remains an influences of oscillation circuits provided inside or outside various ICs (Integrated Circuits) such as a micro computer, a DSP (Digital Processing Unit), and a switching circuit like a digital amplifier.

Moreover, this technology cannot deal with an influence of another electronic equipment which is connected to the receiver in the reference potential. Furthermore, in general, the oscillation frequency of the switching power supply has a relatively large time fluctuation (jitter), the frequency width of a switching frequency spectrum cannot be ignored with respect to the reception frequency step of the receiver in most cases. Therefore, even if a predetermined frequency is controlled, it is hard to completely prevent the jamming or interference because the spectrum of the switching frequency cannot be fully separated from the reception frequency of the receiver. In substantially the same manner, it is technically hard that the one countermeasure for the aforementioned power supply is an effective countermeasure to prevent the generation of the noise, with respect to the circuit structure of a different type from the power supply of the oscillation circuit or the like.

In view of the aforementioned problems, it is therefore an object of the present invention to provide a communicating apparatus which uses electromagnetic waves, which can prevent the reception interference by the noise, and which can improve the SN ratio.

### Means for Solving the Subject

The above object of the present invention can be achieved by a communicating apparatus according to claim 1, provided with: a first antenna for receiving a carrier wave on which an information signal, which is a modulated signal, is superimposed; a ground terminal for bringing a reference potential close to zero; a second antenna, (i) which is connected to the ground terminal and (ii) which has an electromagnetically reverse polarity of the first antenna; and a signal processing device for performing signal processing on the received information signal.

These operation and other advantages of the present invention will become more apparent from the embodiments explained below.

### Best Mode for Carrying Out the Invention

Hereinafter, as the best mode for carrying out the present invention, an explanation will be given on a communicating apparatus in an embodiment of the present invention.

### (Embodiment of Communicating Apparatus)

An embodiment of the communicating apparatus of the present invention is a communicating apparatus provided with: a first antenna for receiving a carrier wave on which an information signal, which is a modulated signal, is superimposed; a ground terminal for bringing a reference potential close to zero; a second antenna, (i) which is connected to the ground terminal and (ii) which has an electromagnetically reverse polarity of the first antenna; and a signal processing device for performing signal processing on the received information signal.

According to the embodiment of the communicating apparatus of the present invention, the carrier wave on which the modulated signal is superimposed is received by the first antenna. Then, the signal processing, such as synchronizing, demodulating, and amplifying, is performed on the received carrier wave by the signal processing device. The “antenna” of the present invention denotes an aerial for receiving the electromagnetic waves used for wireless communication. As one specific example of the antenna, a loop antenna used for an AM receiver and a bar antenna (or linear antenna) used for portable equipment or the like can be listed.

In particular, according to the present invention, the second antenna, which has the electromagnetically reverse polarity of the first antenna, is connected to the ground terminal for bringing the reference potential close to zero.

If there is no second antenna, a variation in the reference potential causes a noise corresponding to an electromotive force generated in an impedance between the terminals of the first antenna. This interferes with the signal processing of the carrier wave and significantly reduces a SN ratio (Signal to Noise Ratio). In contrast, according to the embodiment, the second antenna, which has the electromagnetically reverse polarity of the first antenna, can generate a positive magnetic field for cancelling a negative magnetic field which is generated by the noise corresponding to the electromotive force generated in the impedance between the terminals of the first antenna. Therefore, a reverse electromotive force is generated with respect to the electromotive force generated in the impedance between the terminals of the first antenna. Therefore, the variation in the reference potential can be canceled, so that it is possible to almost or completely cancel the noise generated by the variation in the reference potential.

Consequently, it is possible to almost or completely cancel the noise generated by the variation in the reference potential, to prevent the reception inference, and to dramatically improve the SN ratio, in the communicating apparatus.

In particular, according to the embodiment, it is possible to specify the type, place, or characteristic of the cause for the variation in the reference potential in the communicating apparatus, and it is possible to almost or completely eliminate the need to individually provide the countermeasure.

If in focusing on (i) a circuit method and a circuit structure within the communicating apparatus or (ii) the structure, type, and property of a power supply for supplying an electric power to the signal processing apparatus, it is hard to change the design from that of the existing communicating apparatus in terms of techniques or cost. Because various methods which is for preventing the generation of the noise, endogenously-caused by (i) the circuit method and circuit structure or (ii) the power supply, complicate the design of (i) the circuit method and circuit structure or (ii) the power supply, which is based on a special control method. Even if the generation of the noise from the switching power supply owned by the AM receiver is significantly prevented thanks to the aforementioned patent document 1 or the like, there still remains an influences of oscillation circuits provided inside or outside various ICs (Integrated Circuits) such as a micro computer, a DSP (Digital Processing Unit), and a switching circuit like a digital amplifier. In substantially the same manner, it is technically hard that the countermeasure for the aforementioned power supply is an effective countermeasure to prevent the generation of the noise, with respect to the circuit structure of a different type from the power supply of the oscillation circuit or the like. Moreover, even if the generation of the noise is prevented in one AM receiver thanks to the aforementioned patent document 1 or the like, it is technically hard to prevent the generation of the noise in another electronic equipment that is electrically connected to the one AM receiver.

In contrast, in the embodiment, the variation in the reference potential can be cancelled on the basis of the second antenna which has the electromagnetically reverse polarity of the first antenna, so that it is possible to almost or completely cancel the noise caused by the variation in the reference potential, to prevent the reception interference, and to dramatically improve the SN ratio, radically and appropriately without depending on (i) the circuit method and circuit structure within the communicating apparatus or (ii) the structure, type, and property of the power supply for supplying an electric power to the signal processing apparatus. In addition, according to the embodiment, it is possible to almost or completely cancel the noise in one communicating apparatus, and it is also possible to almost or completely cancel the noise in another electronic equipment that is electrically connected to the one communicating apparatus.

In addition, according to the embodiment, it is only necessary to add the second antenna to the existing communicating apparatus, so that it is possible to dramatically improve the SN ration, simply and inexpensively. Moreover, a user can omit the procedure of grounding the communicating apparatus, which is normally preferred, so that it is possible to significantly improve the user's convenience.

In one aspect of the embodiment of the communicating apparatus of the present invention, (i) one end of the second antenna is connected to the ground terminal and (ii) the other end of the second antenna is open or is terminated in an impedance of a predetermined amount substantially equivalent to the case of being open.

According to this aspect, the other terminal of the second antenna (i,e. a hot terminal) is open or is terminated in an impedance of a predetermined amount substantially equivalent to the case of being open. Here, the predetermined amount in the present invention denotes an amount which is sufficiently large and which can realize the impedance substantially equivalent to the case of being open. The predetermined amount may be defined, individually and specifically, on the experimental, theoretical, experiential, and simulation basis. Thus, the second antenna hardly functions as an antenna aiming for the reception, as in the first antenna, with respect to the carrier wave on which the desired modulated signal is superimposed, in other words, the electromagnetic wave whose reception is desired. As a result, it is possible to cancel the noise while maintaining the high signal level of the desired modulated signal because there is little or no influence on the reception sensitivity and reception property of the first antenna.

In another aspect of the embodiment of the communicating apparatus of the present invention, the first antenna and the second antenna are electromagnetically integrally connected.

According to this aspect, it is possible to cancel the noise, more appropriately and highly accurately; on the basis of the first antenna and the second antenna, which are electromagnetically integrally connected.

In another aspect of the embodiment of the communicating apparatus of the present invention, the ground terminal is connected to (i) a first reference terminal, which is the reference potential of the signal processing device, and (ii) all or a part of circuit elements connected to the first reference terminal.

According to this aspect, the ground terminal of the communicating apparatus is connected to (i) the first reference terminal, which makes the reference potential of the signal processing device, and (ii) the all or a part of circuit elements connected to the first reference terminal, so that it is possible to specify the type, place, or characteristic of the cause for the variation in the reference potential in the power supply, oscillation circuit, or case, and it is possible to almost or completely eliminate the need to individually provide the countermeasure.

If in focusing on (i) the circuit method and circuit structure within the communicating apparatus or (ii) the structure, type, and property of the power supply for supplying an electric power to the signal processing apparatus, it is hard to change the design from that of the existing communicating apparatus in terms of techniques or cost. Because the various methods which is for preventing the generation of the noise, endogenously-caused by (i) the circuit method and circuit structure or (ii) the power supply, complicate the design of (i) the circuit method and circuit structure or (ii) the power supply, which is based on a special control method. Even if the generation of the noise from the switching power supply owned by the AM receiver is significantly prevented thanks to the aforementioned patent document 1 or the like, there still remains an influences of oscillation circuits provided inside or outside various ICs (Integrated. Circuits) such as a micro computer, a DSP (Digital Processing Unit), and a switching circuit like a digital amplifier. In substantially the same manner, it is technically hard that the countermeasure for the aforementioned power supply is an effective countermeasure to prevent the generation of the noise, with respect to the circuit structure of a different type from the power supply of the oscillation circuit or the like. Moreover, even if the generation of the noise is prevented in one AM receiver thanks to the aforementioned patent document 1 or the like, it is technically hard to prevent the generation of the noise in another electronic equipment that is electrically connected to the one AM receiver.

In contrast, in the embodiment, the variation in the reference potential can be cancelled on the basis of the second antenna which has the electromagnetically reverse polarity of the first antenna, so that it is possible to almost or completely cancel the noise caused by the variation in the reference potential, to prevent the reception interference, and to dramatically improve the SN ratio, radically and appropriately without depending on (i) the circuit method and circuit structure within the communicating apparatus or (ii) the structure, type, and property of the power supply for supplying an electric power to the signal processing apparatus.

Specifically, the ground terminal may be connected at least one of (ii) a second reference terminal, which makes the reference potential of a case for storing therein the signal processing device; (iii) a third reference terminal, which makes the reference potential of a power supply; and (iv) a fourth reference terminal, which makes the reference potential of an oscillation circuit provided for the signal processing device.

More specifically, various reference terminals can be listed which make the reference potential of various ICs (Integrated Circuits) such as a micro computer, a DSP (Digital Processing Unit), and a switching circuit like a digital amplifier, in addition to the signal processing device, such as a reception circuit, and the power supply provided in the case.

The plurality of reference terminals may share the reference potential and may be stored in the case in one electronic equipment. Alternatively, the plurality of reference terminals may be stored in a plurality of cases in a plurality of electronic equipments, may be electrically connected over the plurality of cases by a conducting wire such as a pin cable, and may make the common reference potential. As a result, it is possible to almost or completely cancel the noise in one communicating apparatus and it is also possible to almost or completely cancel the noise in another electronic equipment that is electrically connected to the one communicating apparatus.

In another aspect of the embodiment of the communicating apparatus of the present invention, the first antenna and the second antenna are (i) electromagnetically integrally connected and physically integrally connected, or (ii) electromagnetically integrally connected but not physically integrally connected.

According to this aspect, the first antenna and the second antenna are physically integrally connected, so that they cannot be physically different two components; namely, the first antenna may apparently include the second antenna by adding a winding for performing substantially the same operations as the second antenna.

As a result, at a stage of designing, it is possible to design the electromagnetically close connection of the two types of loop antennas with different electromagnetic properties: the first antenna and the second antenna. Thus, it is possible to improve the effect of preventing the jamming or interference by the noise and to further improve the SN ratio. Moreover, a user can use the communicating apparatus with the same recognition and feelings as those for the conventional loop antenna.

Alternatively, the first antenna and the second antenna can be physically different two components because they are electromagnetically integrally connected but not physically integrally connected. As a result, it is only necessary to add a designing process and a manufacturing process for the second antenna to the existing designing process and manufacturing process, so that it is possible to reduce the manufacturing cost.

These operation and other advantages of the present invention will become more apparent from the example explained below.

As explained above, according to the embodiment of the communicating apparatus of the present invention, it is provided with the first antenna, the ground terminal, the second antenna, and the signal processing device. As a result, it is possible to almost or completely cancel the noise caused by the variation in the reference potential, to prevent the reception interference, and to dramatically improve the SN ratio, in the communicating apparatus.

### BRIEF DESCRIPTION OF DRAWINGS

FIG. 1 is a schematic diagram conceptually showing the basic structure of an AM (Amplitude Modulation) receiving apparatus in an example of the communicating apparatus of the present invention.

FIG. 2 is an outside perspective view schematically showing and featuring first and second loop antennas of the basic structure of the AM receiving apparatus in the example of the communicating apparatus of the present invention.

FIG. 3 is a schematic diagram conceptually showing the basic structure of an AM (Amplitude Modulation) receiving apparatus in a comparison example.

FIG. 4 is an outside perspective view schematically showing and featuring a first loop antenna of the basic structure of the AM receiving apparatus in the comparison example.

FIG. 5 are a graph (FIG. 5(a)) quantitatively showing the effect of the example on the basis of gain limited sensitivity (or maximum sensitivity) and a graph (FIG. 5(b)) quantitatively showing the effect of the example on the basis of noise limited sensitivity (or practical sensitivity).

FIG. 6 are a graph (FIG. 6(a)) quantitatively showing the effect of the example on the basis of attenuation and a graph (FIG. 6(b)) quantitatively showing the effect of the example on the basis of a SN ratio.

FIG. 7 is a table quantitatively showing the effect of the example on the basis of the attenuation and the SN ratio.

### DESCRIPTION OF REFERENCE CODES

10 signal processing circuit
20 oscillation circuit
30 switching power supply
100 AM receiving apparatus
A1 first loop antenna
A2 second loop antenna

### Example

Hereinafter, a preferred example of the communicating apparatus of the present invention will be explained with reference to the drawings.

### (1) Basic Structure

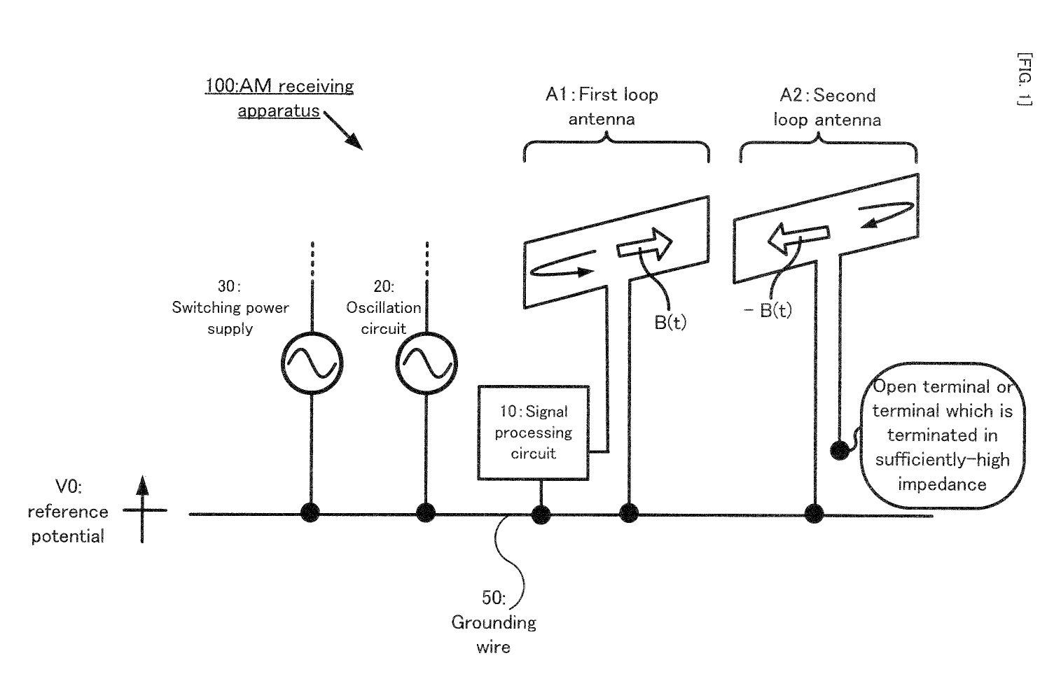

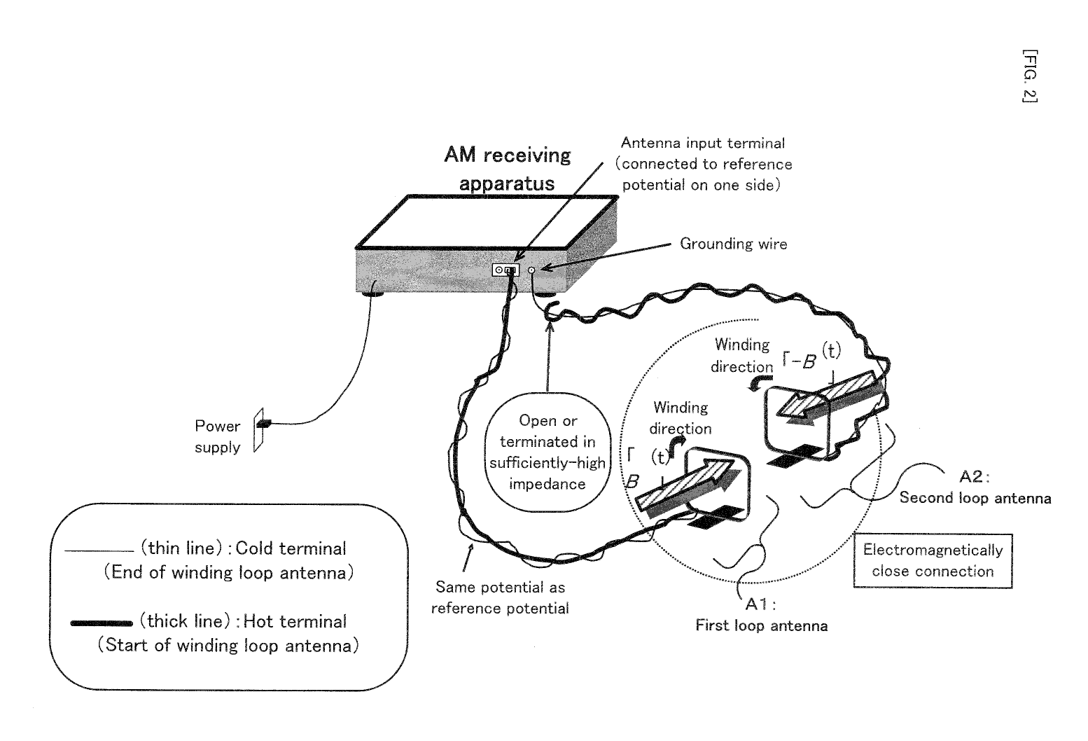

Firstly, with reference to FIG. 1, an explanation will be given on the basic structure of the example of the communicating apparatus of the present invention. FIG. 1 is a schematic diagram conceptually showing the basic structure of an AM (Amplitude Modulation) receiving apparatus (or a receiver) in the example of the communicating apparatus of the present invention. FIG. 2 is an outside perspective view schematically showing and featuring first and second loop antennas of the basic structure of the AM receiving apparatus in the example of the communicating apparatus of the present invention.

As shown in FIG. 1, an AM receiving apparatus 100 in the example, is provided with a first loop antenna A1, a second loop antenna A2, a signal processing circuit 10, an oscillation circuit 20, a switching power supply 30, and a grounding wire 50. Incidentally, in the example, the loop antenna used for the AM receiver, is used as one specific example of the “antenna” of the present invention; however, it is also possible to use a bar antenna (or a linear antenna), which is used for portable equipment or the like.

In particular, in the example, the grounding wire 50 may be connected to all the circuit elements that are connected to reference terminals, which is the reference potential of the signal processing circuit 10, in addition to be the reference potential of the electronic element described above. More specifically, the grounding wire 50 may be connected to (i) the reference terminal, which is the reference potential of the power supply; and (ii) the reference terminal, which is the reference potential of an oscillation circuit provided for the signal processing circuit 10. More specifically, it is possible to list various reference terminals, which is the reference potential in the oscillation circuits provided inside or outside various ICs (Integrated Circuits) such as a micro computer, a DSP (Digital Processing Unit), and a switching circuit like a digital amplifier, in addition to be the reference potential of the power supply which exists in a case and a signal processing device such as a reception circuit or a receiving circuit. The plurality of reference terminals may be stored within the case of one electronic equipment, with the reference potential as a common reference potential. Alternatively, the plurality of reference terminals may be stored in respective cases of a plurality of electronic equipments, may be electrically connected over the plurality of cases by a conducting wire such as a pin cable, and may be the common reference potential. As a result, it is possible to almost or completely cancel the noise in one communicating apparatus and it is also possible to almost or completely cancel the noise in another electronic equipment that is electrically connected to the one communicating apparatus.

In the first loop antenna A1 and the second loop antenna A2, an element (i.e. a conducting wire, a conductor portion) is made cyclic (or looped). This type of loop antenna is formed by winding the conducting wire several times with a diameter larger than that of the normal coil used as an electronic part. The operation principle of the loop antenna uses that an induced electromotive force is extracted by using a change in a magnetic field within the coil. In this case, the length of the conducting wire of the loop antenna is not directly related to the operations. Most loop antennas are used as a resonance circuit, with it connected to a condenser. More specifically, as this representative product, a long distance reception antenna for a medium-wave-band AM radio is commercially available. This is to be synchronized by a variable condenser with a coil in a shape of triangle, quadrangle, or the like having a diameter of about one meter, and this is to be electrically connected to the bar antenna built in the radio. Incidentally, the details of the first loop antenna A1 and the second loop antenna A2 in the example, will be detailed later.

The signal processing circuit 10 is an electronic circuit installed in a general AM radio, and the signal processing circuit 10 is provided with, for example, a high-frequency amplifier, a mixer, the aforementioned oscillation circuit 20 (a so-called local oscillator), an intermediate frequency amplifier, a demodulator, and a low-frequency amplifier. The signal processing circuit 10 is connected to the grounding wire 50 and operates on the basis of the reference potential of the grounding wire 50.

The switching power supply 30 is a power supply apparatus which uses a switching element (e.g. an element that allows one portion of an electric circuit such as a switching circuit to be turned on or off) for converting or adjusting an electric power, on an electric power converting apparatus which obtains a desired output power from an input power. In particular, the switching power supply 30 may be a so-called switching regulator. Specifically, the switching power supply 30 may be a DC-to-DC convertor which converts a direct-current power to another direct-current power, or it may be a power supply apparatus provided with a rectifying apparatus (an AC-to-DC convertor) for converting an alternating-current power to a constant direct-current power. More specifically, a switching circuit provided for the switching power supply 30 switches, i.e. turns on and off, a direct-current voltage smoothed by an electrolytic capacitor, at high frequencies of several kHz to several MHz. By switching at the high frequencies, it is possible to reduce an inductance necessary for a trance or a choke coil. Namely, it is possible to reduce the number of turns and core of the trance or the choke coil, leading to miniaturization.

In the AM receiving apparatus 100, in general, a reference potential V0, i.e. GNB (Ground), has substantially the same potential (i.e. potential level) as one terminal of the first loop antenna A1 (i.e. a cold terminal: refer to a thin line connected to the first loop antenna A1 in FIG. 2) for receiving a carrier wave on which a modulated signal is superimposed. Thus, a variation in the reference potential V0 of the grounding wire 50 causes an electromotive force in the impedance of the first loop antenna A1. Therefore, a voltage is generated between two terminals (i.e. antennal terminals) of the first loop antenna Al. Incidentally, the voltage generated between the two terminals because of the reference potential variation, is denoted by “v(t)” in which time “t” is a variable. The voltage “v(t)” is a noise voltage (i.e. an interference or disturbance voltage) which interferes with appropriate signal processing. The voltage “v(t)” reduces the relative signal level of the desired modulated signal superimposed on the carrier wave and significantly reduces a SN ratio (Signal to Noise Ratio). Incidentally, a magnetic field “B(t)”, uniquely determined from the voltage v(t), is generated from the first loop antenna A1. The magnetic field “B(t)” approaches zero, when the voltage v(t) approaches zero.

In particular, the AM receiving apparatus 100 in the example, is provided with the second loop antenna A2, as shown in FIG. 1 and FIG. 2. One terminal of the second loop antenna A2 (i.e. a cold terminal: refer to a thin line connected to the second loop antenna A2 in FIG. 2) is connected to the reference potential V0 of the grounding wire 50 in the AM receiving apparatus 100. And the other terminal (i.e. a hot terminal) is open to the air as an open terminal (refer to a thick line connected to the second loop antenna A2 in FIG. 2), or is terminated in an impedance of a predetermined amount substantially equivalent to the case of being open. Here, the predetermined amount in the example, denotes an amount that is large enough and that can realize the impedance substantially equivalent to the case of being open. The predetermined amount may be defined, individually and specifically, on an experiment, theoretic, experiential, or simulation basis.

As described above, any one of the antenna input terminals owned by the AM receiving apparatus, is connected to the reference potential. At the same time, the second loop antenna A2 has the electromagnetically reverse polarity of the first loop antenna A1. Therefore, the second loop antenna A2 can function as an antenna for cancelling the noise caused by the variation in the reference potential. Specifically, a winding direction in the conducting wire of the second loop antenna A2, is preferably opposite to a winding direction of the first loop antenna A1. Here, the “hot terminal” in the example, denotes a terminal corresponding to a position at which the loop antenna starts winding. Moreover, the “cold terminal” in the example, denotes a terminal corresponding to a position at which the loop antenna ends winding. Incidentally, the conducing wire connected to the “hot terminal” in FIG. 2, is shown in the thick line, and the conducting wire connected to the “cold terminal” in FIG. 2, is shown in the thin line.

In addition, the first loop antenna Al and the second loop antenna A2 are preferably connected closely and integrally as much as electromagnetically possible (refer to a circle which indicates the “electromagnetically close connection” in FIG. 2). Specifically, the first loop antenna Al and the second loop antenna A2 may be (i) electromagnetically integrally connected and physically integrally connected. The first antenna and the second antenna are physically integrally connected, so that they cannot be physically different two components. Namely, the first antenna may apparently include the second antenna by adding a winding for performing substantially the same operations as the second antenna.

As a result, at a stage of designing, it is possible to design the electromagnetically close connection of the two types of loop antennas with different electromagnetic properties: the first antenna and the second antenna. Thus, it is possible to improve the effect of preventing the jamming or interference by the noise and to further improve the SN ratio. Moreover, a user can use the communicating apparatus with the same recognition and feelings as those for the conventional loop antenna.

Alternatively, the first antenna and the second antenna may be (ii) electromagnetically integrally connected but not physically integrally connected. Therefore, they can be physically different two components. As a result, it is only necessary to add a designing process and a manufacturing process for the second antenna to the existing designing process and manufacturing process, so that it is possible to reduce the manufacturing cost. As described above, the magnetic field “B(t)”, caused by the potential variation in the reference potential V0 of the grounding wire 50, is generated from the first loop antenna A1. On the other hand, from the second loop antenna A2, a reverse magnetic field “−B(t)” is generated. Thus, the magnetic field “B(t)” generated in the first loop antenna Al and the magnetic field “−B(t)” generated in the second loop antenna A2 cancel each other. Therefore, simultaneously with the magnetic field “B(t)” generated in the first loop antenna A1 approaching zero, the voltage “v(t)” generated between the two terminals of the first loop antenna Al approaches zero.

As a result, by almost or completely cancelling the noise caused by the variation in the reference potential V0 in the AM receiving apparatus 100, it is possible to prevent the reception interference and it is also possible to dramatically improve the SN ratio.

In particular, the other terminal (i.e. hot terminal) of the second loop antenna A2 is open or is terminated in the impedance of the predetermined amount substantially equivalent to the case of being open. Thus, the second loop antenna A2 does not function as an antenna aiming for the reception, as in the first loop antenna A1, because the impedance is substantially infinite, with respect to the carrier wave on which the desired modulated signal is superimposed, in other words, with respect to the electromagnetic wave whose reception is desired.

### (2) First Study on Operation and Effect in Example

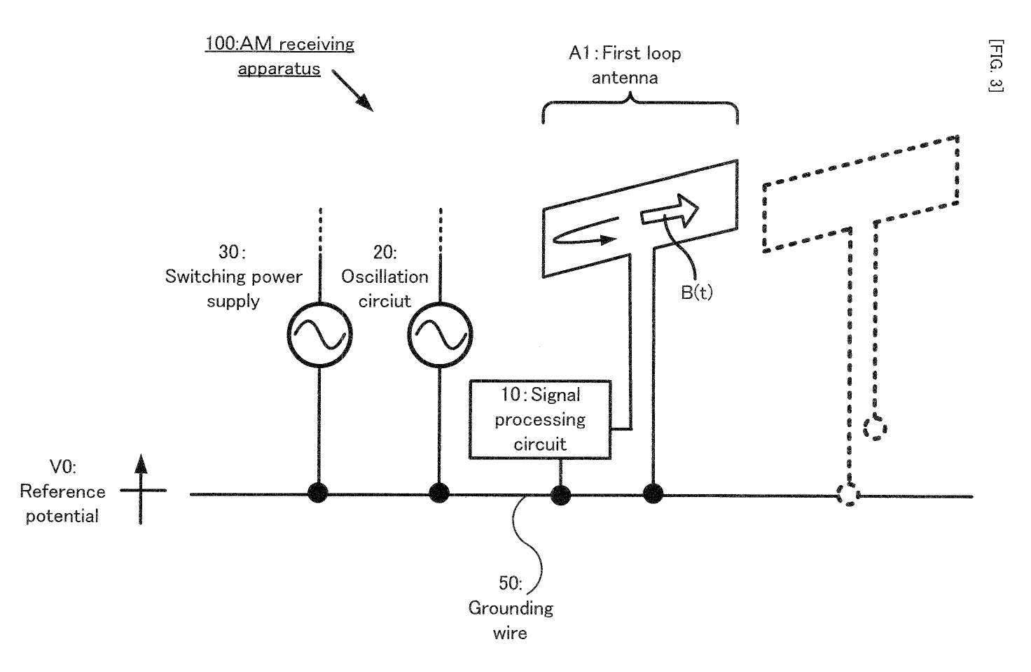

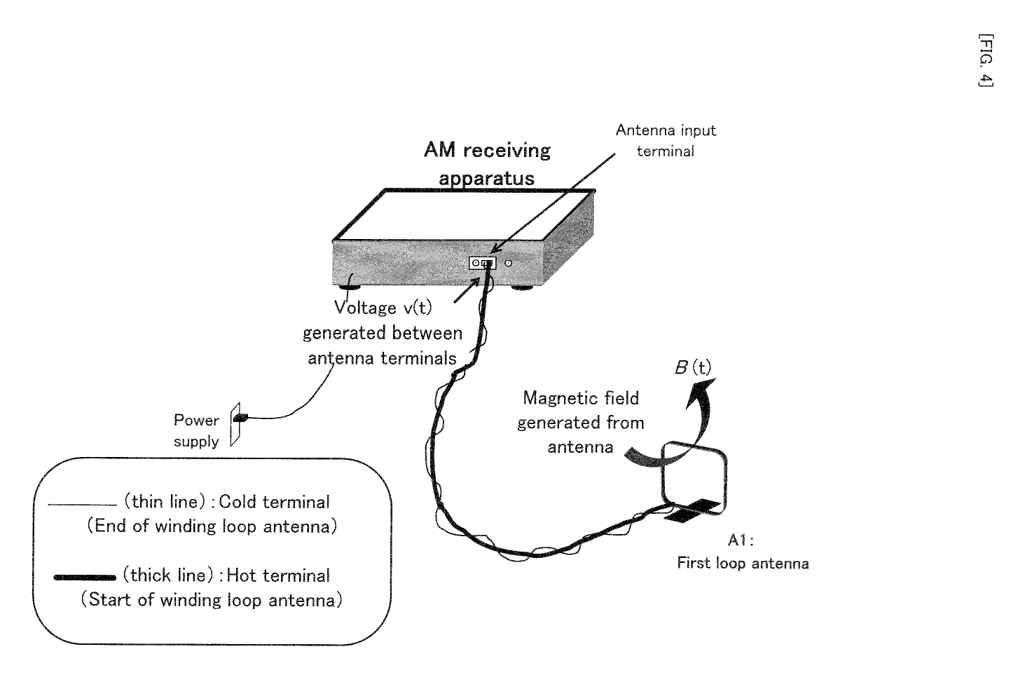

Next with reference to the aforementioned FIG. 1 and FIG. 2 as occasion demands in addition to FIG. 3 and FIG. 4, a first study is given to the operation and effect in the example. FIG. 3 is a schematic diagram conceptually showing the basic structure of an AM (Amplitude Modulation) receiving apparatus (or a receiver) in a comparison example. FIG. 4 is an outside perspective view schematically showing and featuring a first loop antenna of the basic structure of the AM receiving apparatus in the comparison example.

As shown in FIG. 3 and FIG. 4, in the AM receiving apparatus 100 in the comparison example, the reference potential V0, i.e. GND (Ground), has substantially the same potential (i.e. potential level) as one terminal of the first loop antenna A1 (i.e. a cold terminal: refer to a thin line connected to the first loop antenna A1 in FIG. 4) for receiving an information signal. Thus, the variation in the reference potential V0 of the grounding wire 50 causes an electromotive force in the impedance of the first loop antenna A1. Therefore, a voltage is generated between two terminals (i.e. antennal terminals) of the first loop antenna A1. The voltage “v(t)” is a noise voltage (i.e. an interference or disturbance signal) which interferes with appropriate signal processing. The voltage “v(t)” reduces the relative signal level of the desired modulated signal superimposed on the carrier wave and significantly reduces the SN ratio.

In contrast, the AM receiving apparatus 100 in the example, as shown in the aforementioned FIG. 1 and FIG. 2, is provided with the second loop antenna A2. One terminal of the second loop antenna A2 (i.e. a cold terminal) is connected to the reference potential V0 of the grounding wire 50 in the AM receiving apparatus 100. And the other terminal (i.e. a hot terminal) is open to the air as an open terminal or is terminated in an impedance of a predetermined amount substantially equivalent to the case of being open. At the same time, the second loop antenna A2 has the electromagnetically reverse polarity of the first loop antenna A1. Therefore, the second loop antenna A2 can function as an antenna for cancelling the noise caused by the variation in the reference potential.

As a result, it is possible to almost or completely cancel the noise caused by the variation in the reference potential V0, to prevent the reception interference, and to dramatically improve the SN ratio, in the AM receiving apparatus 100.

In addition, according to the example, it is possible to specify the type, place, or characteristic of the cause for the variation in the reference potential in the AM receiving apparatus 100, and it is possible to almost or completely eliminate the need to individually provide the countermeasure.

If in focusing on (i) the circuit method and circuit structure within the AM receiving apparatus 100 or (ii) the structure, type, and property of the switching power supply 30 for supplying an electric power to the signal processing apparatus, it is hard to change the design from that of the existing AM receiving apparatus 100 in terms of techniques or cost. Because the various methods, which is for preventing the generation of the noise, endogenously-caused by (i) the circuit method and circuit structure or (ii) the switching power supply 30 complicate the design of (i) the circuit method and circuit structure or (ii) the switching power supply 30, which is based on a special control method. In substantially the same manner, it is technically hard that the one countermeasure for the aforementioned switching power supply 30 is an effective countermeasure to prevent the generation of the noise, with respect to the circuit structure of a different type from the power supply of the oscillation circuit or the like.

In contrast, in the example, the variation in the reference potential can be cancelled on the basis of the second loop antenna A2 which has the electromagnetically reverse polarity of the first loop antenna A1, so that it is possible to almost or completely cancel the noise caused by the variation in the reference potential And it is possible to prevent the reception interference, and it is possible to dramatically improve the SN ratio, radically and appropriately, without depending on (i) the circuit method and circuit structure within the AM receiving apparatus 100 or (ii) the structure, type, and property of the switching power supply 30 for supplying an electric power to the signal processing apparatus.

In addition, according to the example, it is only necessary to add the second loop antenna A2 to the existing AM receiving apparatus 100, so that it is possible to prevent the reception interference and to dramatically improve the SN ration, simply and inexpensively. Moreover, a user can omit the procedure of grounding the AM receiving apparatus 100, which is normally preferred, so that it is possible to significantly improve the user's convenience.

### (3) Second Study on Effect in Example

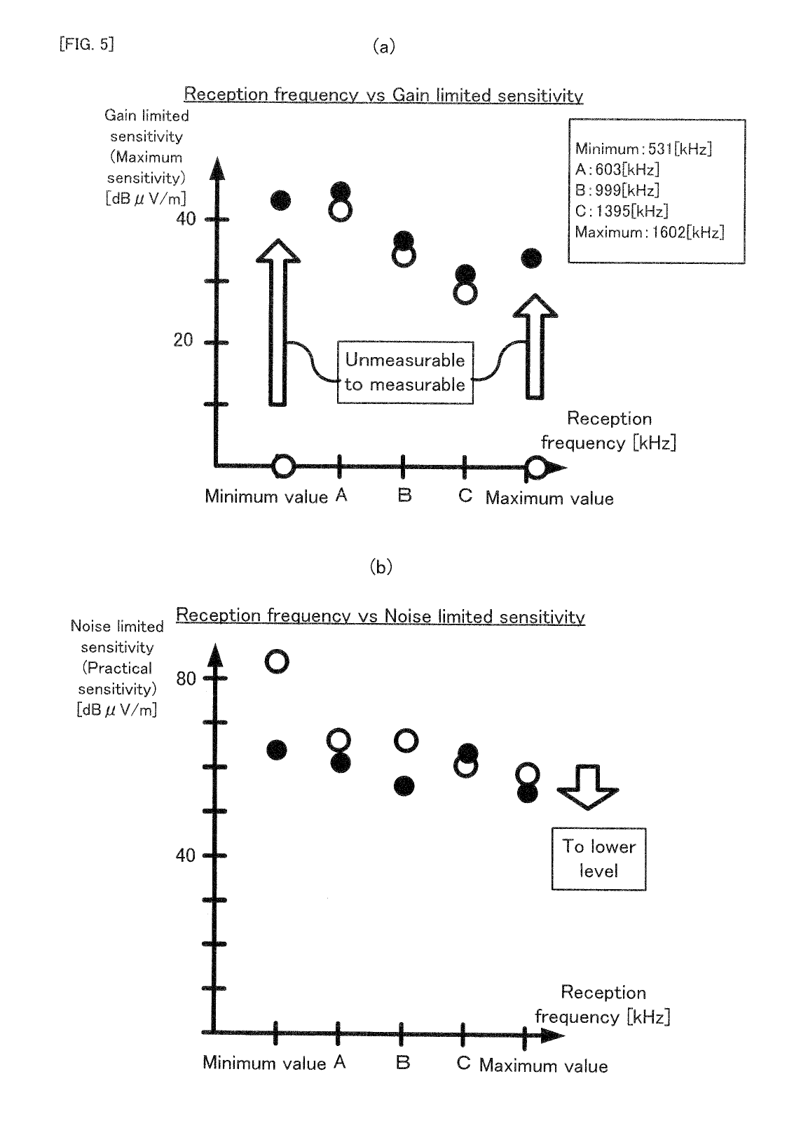

Next with reference to the aforementioned FIGS. 5, a second study is given to the effect in the example. FIGS. 5 are a graph (FIG, 5(a)) quantitatively showing the effect of the example on the basis of gain limited sensitivity (or maximum sensitivity) and a graph (FIG. 5(b)) quantitatively showing the effect of the example on the basis of noise limited sensitivity (or practical sensitivity).

As shown in FIG. 5(a), according to the research by the present inventors, it is found out that the maximum sensitivity, which cannot be measured in the comparison example, can be measured in the AM receiving apparatus 100 in the example. As a result, it is found out that the noise caused by the variation in the reference potential V0, is almost or completely cancelled, it is found out that the reception interference is prevented, and it is found out that the SN ratio is dramatically improved, in the AM receiving apparatus 100. Here, the “gain limited sensitivity (or maximum sensitivity)” in the example, denotes the level of an input signal of the AM receiving apparatus, which is to output an output signal at a constant level, under the influence of the noise, in the AM receiving apparatus. Specifically, the graph in FIG. 5(a), indicates such a level of the input signal that the level of the output signal is “−10(dB)”, if the output signal level is 0 dB when a reference input signal (74 dB μV/m) is inputted. Incidentally, the unit (dB μV/m) denotes a physical unit which indicates electric field intensity. The lower gain limited sensitivity (or maximum sensitivity) means that the modulated signal can be listened to even at the lower input signal level. In general, the lower maximum sensitivity is considered to have a better reception capability.

However, if the apparatus is suppressed by the noise caused by the variation in the reference potential, the noise is measured as the output signal, regardless of the magnitude of the input signal level. Thus, a value below the maximum sensitivity actually owned by the receiver, is measured. And the maximum sensitivity cannot be also measured in many cases, if the suppression level by the noise is high.

Specifically, as shown in “white circles” in FIG. 5(a), the gain limited sensitivity in the comparison example, shows “NG (No Good: unmeasurable)” in the minimum reception frequency and the maximum reception frequency.

That is to say, the maximum sensitivity cannot be measured because of the suppression by the noise caused by the reference potential variation of the receiver from the switching power supply or the like provided in measured equipment. In contrast, the maximum sensitivity in the example, as shown in “black circles” in FIG. 5(a), shows values of “42” and “34” in the minimum reception frequency and the maximum reception frequency, respectively. It indicates that the noise caused by the switching power supply or the like provided in the measured equipment, is canceled and it indicates that the maximum sensitivity can be measured. Incidentally, arrows in FIG. 5(a) indicate that the measurement can be changed from being incapable to being capable in the example, if the reception frequency has the minimum value or the maximum value. Moreover, in the reception frequency in FIG. 5(a) and in FIG. 5(b) described later, the minimum value indicates “531 (kHz)”, a value “A” indicates “603 (kHz)”, a value “B” indicates “999 (kHz)”, a value “C” indicates “1395 (kHz)”, and the maximum value indicates “1602 (kHz)”.

As shown in “black circles” in FIG. 5(b), according to the research by the present inventors, it is found out that the level of the noise limited sensitivity (or practical sensitivity) is substantially lower than that in the comparison example shown by “white circles”, in the AM receiving apparatus 100 in the example. As a result, it is found out that the noise caused by the variation in the reference potential V0, is almost or completely cancelled, it is found out that the reception interference is prevented, and it is found out that the SN ratio is dramatically improved, in the AM receiving apparatus 100. Here, the “noise limited sensitivity (or practical sensitivity)” in the example, denotes the level of an input signal which is inputted to the AM receiving apparatus when a constant SN ratio is obtained in the output signal under the influence of the noise, in the AM receiving apparatus. Specifically, the graph in FIG. 5(b) indicates a minimum input signal level to obtain a SN ratio of 30 dB on the basis of the output signal level when the reference input signal (74 dB μV/m) is inputted. The lower noise limited sensitivity (or practical sensitivity) means that the modulated signal can be listened to even at the lower input signal level without a problem in listening. In general, the lower practical sensitivity is considered to have a better reception capability.

Specifically, as shown in the “black circles” in FIG. 5(b), it is found out that the noise limited sensitivity (or practical sensitivity) in the example, has values of “61”, “60”, “55”, “64”, and “53”, in the minimum reception frequency, a frequency “A”, a frequency “B”, a frequency “C”, and the maximum reception frequency, respectively, and that they are substantially lower than the noise limited sensitivity “83”, “65”, “65”, “62”, and “58”, respectively, in the comparison shown by “white circles” in FIG. 5(b). This indicates that the practical sensitivity is improved by that the noise caused by the switching power supply or the like provided in the receiver, is eliminated, that the noise level with respect to the output signal level is relatively reduced, and that the SN ratio is improved, in the example.

### (4) Third Study on Effect in Example

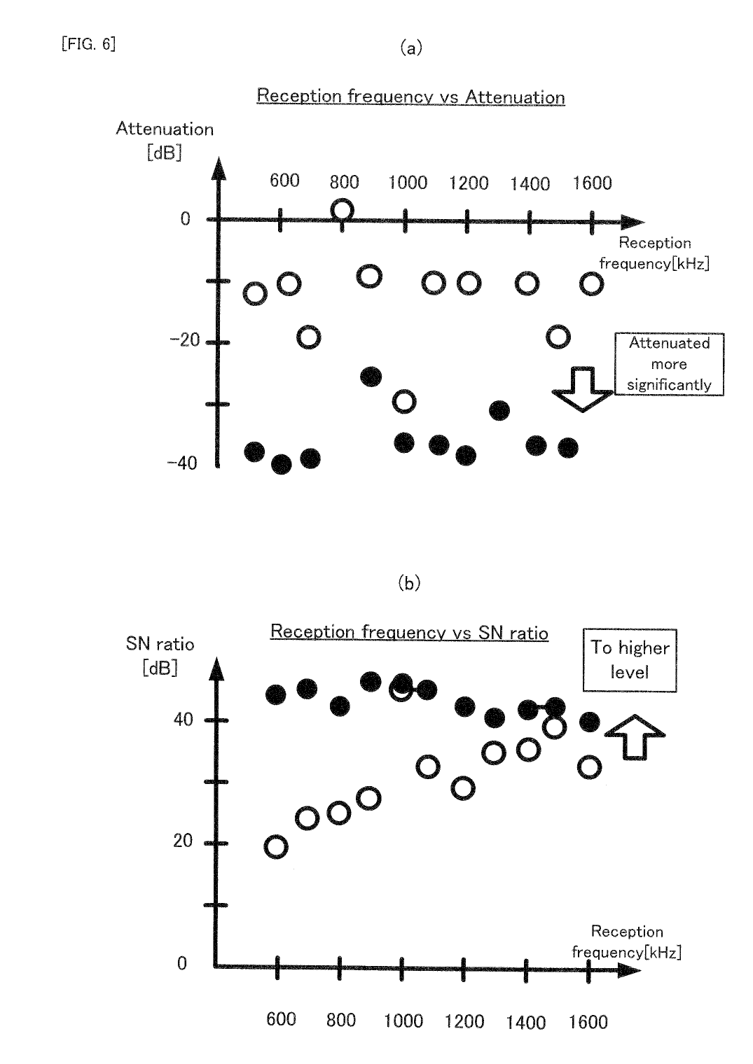

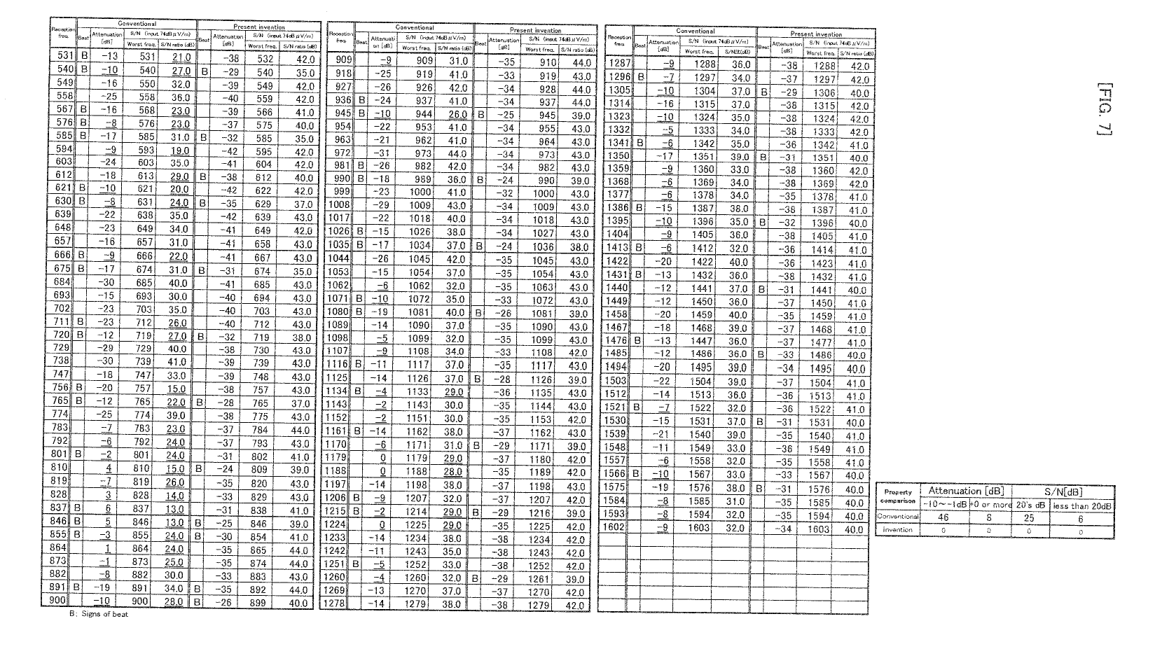

Next with reference to the aforementioned FIGS. 6 and FIG. 7, a third study is given to the effect in the example. FIGS. 6 are a graph (FIG. 6(a)) quantitatively showing the effect of the example on the basis of attenuation and a graph (FIG. 6(b)) quantitatively showing the effect of the example on the basis of a SN ratio. FIG. 7 is a table quantitatively showing the effect of the example on the basis of the attenuation and the SN ratio.

As shown in “black circles” in FIG. 6(a), according to the research by the present inventors, it is found out that the level of the attenuation is more significantly reduced than the level of the attenuation in the comparison example shown by “white circles”, in the AM receiving apparatus 100 in the example. As a result, it is found out that the noise produced and caused by the variation in the reference potential V0, is almost or completely cancelled, it is found out that the reception interference is prevented, and it is found out that the SN ratio is dramatically improved, in the AM receiving apparatus 100. Here, the “attenuation” in the example denotes how much the output signal level is attenuated if the input signal is minimal on the basis of the output signal level (0dB) when the reference input signal is inputted. Specifically, the graph in FIG. 6(a) indicates by a dB unit how much the output signal level is attenuated, if the input signal is “−∞” (dBμV/m) on the basis of the output signal level (0 dB) when “74” (dBμV/m) is inputted as the input signal. The higher attenuation means that there is less interference or that jamming by the noise is less. In general, the higher attenuation is considered to be better.

Specifically, as shown in the “black circles” in FIG. 6(a), it is found out that the attenuation in the example has values of “−40” to “−26” in the reception frequencies of “531 (Hz)” to “1602 (Hz)” and it is found out that the attenuation in the example, is more significantly reduced in any of the reception frequencies than the attenuation of “−30” to “+6” in the comparison example shown in the “white circles” in FIG. 6(a).

More specifically, as shown in the table in FIG. 7, in the comparison example, there are “46” points of the sampled frequencies at which the attenuation is “−10 (dB)” to “−1 (dB)”. In contrast, in the embodiment, there are “0” points of the sampled frequencies at which the attenuation is “−10 (dB)” to “−1 (dB)”. Substantially in the same manner, in the comparison example, there are “8” points of the sampled frequencies at which the attenuation is “0 (dB)” or more. In contrast, in the embodiment, there are “0” points of the sampled frequencies at which the attenuation is “0 (dB)” or more.

As described above, in the AM receiving apparatus 1.00 in the example, it is found out that the level of the attenuation is more significantly reduced than in the comparison example. As a result, it is found out that the noise produced and caused by the variation in the reference potential V0 is almost or completely cancelled, it is found out that the reception interference is prevented, and it is found out that the SN ratio is dramatically improved, in the AM receiving apparatus 100.

As shown in the “black circles” in FIG. 6(b), according to the research by the present inventors, it is found out that the level of the SN ratio is higher than that the level of the SN ratio in the comparison example shown in “white circles” in FIG. 6(b), in the AM receiving apparatus 100 in the example. As a result, it is found out that the noise caused by the variation in the reference potential V0 is almost or completely cancelled, it is found out that the reception interference is prevented, and it is found out that the SN ratio is dramatically improved, in the AM receiving apparatus 100. Here, the “SN ratio” in the example denotes a ratio in the output level between with and without the modulated signal by the dB unit, on the condition that a constant level of signal is inputted to the receiving apparatus. Specifically, the graph in FIG. 6(b) indicates by the dB unit the ratio in the output level between with the modulated signal (i.e. sine wave of 400 Hz) (in a modulation factor of 30%) and without the modulated signal (in a modulation factor of 0%), on the condition that the reference input signal (74 dBμV/m) is inputted to the receiver. The higher SN ratio means that the noise level is relatively small with respect to the modulated signal level and that a signal with less noise in listening can be listened to. In general, the higher SN ratio is considered to provide a better receiver performance.

Specifically, as shown in the “black circles” in FIG. 6(b), it is found out that the SN ratio in the example has values of “39” to “43” in the reception frequencies of “531 (Hz)” to “1602 (Hz)”, and that the SN ratio in the example indicates a higher value in any of the reception frequencies than the SN ratio of “13” to “29” in the comparison example shown in the “white circles” in FIG. 6(b).

More specifically, as shown in the table in FIG. 7, in the comparison example (refer to columns of “conventional” in FIG. 7), there are “25” points of the sampled frequencies at which the SN ratio is in its “20s (dB)”. In contrast, in the embodiment, there are “0” points of the sampled frequencies at which the SN ratio is in its “20s (dB)”.

Substantially in the same manner, in the comparison example, there are “6” points of the sampled frequencies at which the SN ratio is less than “20 (dB)”. In contrast, in the embodiment, there are “0” points of the sampled frequencies at which the SN ratio is less than “20 (dB)”.

As described above, in the AM receiving apparatus 100 in the example, it is found out that the level of the SN ratio is higher than that in the comparison example. As a result, it is found out that the noise caused by the variation in the reference potential V0, is almost or completely cancelled, it is found out that the reception interference is prevented, and it is found out that the SN ratio is dramatically improved, in the AM receiving apparatus 100.

In the aforementioned example, for example, the household or on-vehicle AM receiving apparatus, receiver, and transmitter are explained; however, the present invention can be applied to all the communicating apparatuses using electromagnetic waves, such as video equipment and communication equipment for household use, or video equipment, communication equipment, and communication apparatus, for business use.

The present invention is not limited to the aforementioned example, but various changes may be made, if desired, without departing from the essence or spirit of the invention which can be read from the claims and the entire specification. A communicating apparatus, which involves such changes, is also intended to be within the technical scope of the present invention.

### INDUSTRIAL APPLICABILITY

The communicating apparatus of the present invention can be applied to, for example, a household or on-vehicle AM receiving apparatus, receiver, and transmitter. Moreover, the communicating apparatus of the present invention can be also applied to all the communicating apparatuses using electromagnetic waves, such as video equipment and communication equipment for household use, or video equipment, communication equipment, and communication apparatus, for business use.

1. A communicating apparatus comprising;
a first antenna for receiving a carrier wave on which an information signal, which is a modulated signal, is superimposed;
a ground terminal for bringing a reference potential close to zero;
a second antenna, (i) which is connected to said ground terminal and (ii) which has an electromagnetically reverse polarity of said first antenna; and
a signal processing device for performing signal processing on the received information signal.

2. The communicating apparatus according to claim 1, wherein (i) one end of said second antenna is connected to said ground terminal and (ii) the other end of said second antenna is open or is terminated in an impedance of a predetermined amount substantially equivalent to the case of being open.

3. The communicating apparatus according to claim 1, wherein said first antenna and said second antenna are electromagnetically integrally connected.

4. The communicating apparatus according to claim 1, wherein said ground terminal is connected to (i) a first reference terminal, which is the reference potential of said signal processing device, and (ii) all or a part of circuit elements connected to said first reference terminal.

5. The communicating apparatus according to claim 1, wherein said first antenna and said second antenna are (i) electromagnetically integrally connected and physically integrally connected, or (ii) electromagnetically integrally connected but not physically integrally connected.
